(19) United States
(12) Patent Application Publication
(10) Pub. No.: US 2003/0185975 A1
(43) Pub. Date: Oct. 2, 2003

(54) Process for preparing low-dielectric-constant silica film

(76) Inventors: Ben-Zu Wan, Taipei (TW); Chih-Yuan Ting, Taipei (TW); De-Fa Ouyan, Junghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/105,293

(22) Filed: Mar. 26, 2002

(51) Int. Cl. B05D 3/12; B05D 3/02

(52) U.S. Cl. 427/240; 427/387

(57) ABSTRACT

A process for preparing low-dielectric-constant silica film is developed. The dielectric constant of said film are lower than 2.5. Said process comprises a) preparing spin coating solution, said solution being composed of silica precursor, deionized water, alcohol, single proton acid, and polyoxyethylene (20) sorbitan compounds also known as Tween group compounds as templates; the weight ratio of polyoxyethylene (20) sorbitan compounds over TEOS being more than 0.41; b) spin-coating the said solution into a film; c) removing most water and alcohol in said film and making the film react with silicon wafer in soft-bake process; d) removing said polyoxyethylene (20) sorbitan compound of said film in calcination process; and e) Modifying said film to hydrophobic by dehydroxylating said film.

### FIELD OF THE INVENTION

The present invention relates to a low-dielectric-constant silica film and more particularly a process for preparing low-dielectric-constant silica film.

### BACKGROUND OF THE INVENTION

As feature sizes in integrated circuits approach 0.13 μm (transistor gate length) and below, problems with propagation delay, crosstalk noise, and power dissipation due to resistance-capacitance (RC) coupling become significant. In order to solve these problems, it is hoped to introduce low-dielectric-constant (k<2.0) materials as the interlayer dielectric in the future advanced microprocessors. Currently in the progress of low k materials, one of the approaches is to develop nanoporous silica films with k in the range of 1.3 to 3.0. Porous silica films can be prepared through three different ways: (1) by an aerogel or a xerogel process; (2) by a templating process, (3) by a zeolite suspension process. Films prepared by aerogel or xerogel process usually have a random pore size distribution and the pore sizes are larger than 50 Å, which are not favored in the semiconductor industry. Therefore, researchers are now focusing on the surfactant-templating process and the zeolite suspension process. Films prepared from zeolite suspension colloid usually have excellent mechanical strength. This is due to nano-sized zeolite was used as the building block in the film. Because zeolite is crystalline, films with interconnected zeolite would possess good mechnical properties. However, there are two drawbacks for this process. First, it takes a long period of time (for hydrothermal treatment and centrifugation) to prepare the colloid solution with the right sizes of zeolite. Second, the channel size in the zeolite (i.e., silicalite) is about 5.5 Å, which may be too small for organosilanes such as TMCS (Trimethylchlorosilane) or HMDS (1,1,1,3,3,3-Hexamethyldisilazane) easily to diffuse into the pores of the crystals and modify the pore surface to be hydrophobic. As a result, the film prepared in this way would absorb some amount of water, which causes the bulk dielectric constant to elevate. So far, the lowest dielectric constant obtained by this method was 1.8, and it gradually rises to 2.1 when time goes by.

Recently low dielectric constant mesoporous silica films prepared from templating method were reported by two research groups. Polyoxyethylene ether surfactant and P123 (Pluronic) triblock copolymer were used as the templates in the ethanol solution TEOS (tetraethylorthosilicate) was used as a silica source. It was found that the pore size in the film can be controlled in the range of 20 to 50 Å, which allows organosilane molecules easily to enter and to modify the surface. And it has been proved that porous silica films prepared by this method show great potential in the future semiconductor industry. However, for porous silica films prepared with polyoxyethylene ether surfactant as the template, it is required 20 h for aging the colloid mixture. Besides, the low dielectric constants of the spin-coated films are only in the range of 1.80 to 2.50. Therefore, there are questions about whether a shorter colloid preparation process can be developed, and whether the films with lower dielectric constants can be made. On the other hand, ultralow dielectric constants in the range of 1.42 to 2.50 prepared from colloid with P123 triblock copolymer as the template were reported. But the additional TEOS reflux step and TMCS mixing step for the preparation of coating solution make this film preparation process even longer and more complicate.

The above and other objects, features and advantages of the present invention will become apparent from the following detailed description taken with the accompanying drawings.

### BRIEF DESCRIPTION OF THE DRAWINGS

FIG. 1(a) is a cross-sectional SEM image of the surfactant-templating mesoporous film prepared from the colloid with Tween 80 as the template of the present invention;

FIG. 1(b) is a top view AFM image of the present invention;

FIG. 2 is the diagram showing variation of the dielectric constant and leakage current at an electric field of 1 MV/cm for films prepared from colloids with different amounts of Tween 80; and

FIG. 3 is the diagram showing variation of the dielectric constant and leakage current at an electric field of 1 MV/cm for films prepared from colloids with different amounts of HCl.

### SUMMARY OF THE INVENTION

Therefore it is an objective of the invention to provide a short and efficient process for preparing nanoporous spin-on silica films with dielectric constant in the range of 1.4 to 2.5 ; said process comprises

a) using nonionic polyoxyethylene (20) sorbitan compounds as templates in said process;

b) developing proper composition and concentration of spin coating solution suitable for said process

c) developing spin coating procedures in said process;

d) developing baking procedures in said process;

e) developing calcination procedures in said process; and

f) developing film dehydroxylating procedures in said process.

Films prepared in this invention have the properties such as ultra low dielectric constants (from 1.4 to 2.5) and low leakage current densities (at 10⁻⁷ A/cm² order or even lower under an electric field of 1 MV/cm). Films prepared from said process are qualified candidates for future intermetal dielectrics.

### DETAILED DESCRIPTION OF THE PREFERRED EMBODIMENTS

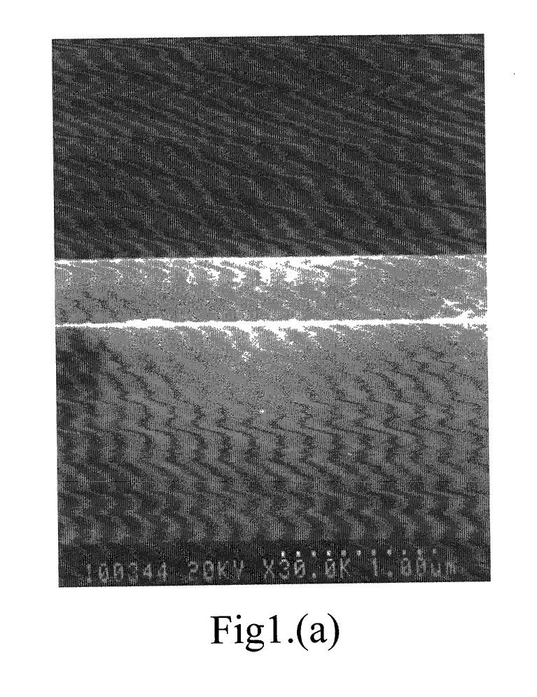

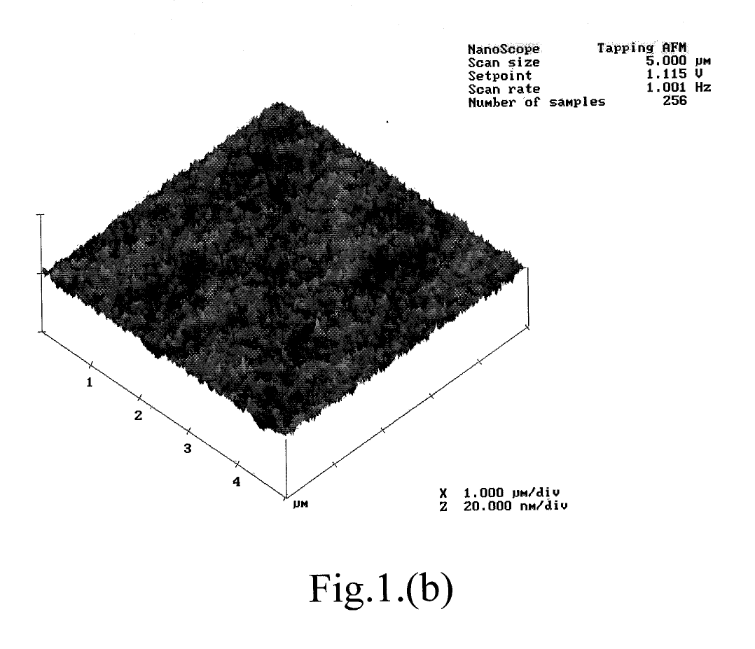

In present invention, we report the preparation of ultra low dielectric constant films from a one-step-prepared silica colloid solution. The process is simpler than those previous reported. Porous silica films (about 5000 Å thickness) with dielectric constant in the range of 1.47 to 1.93 and leakage current density of 10⁻⁷ order can be prepared. And the dielectric constant of the film remains almost the same even the film is exposed in atmosphere for 30 days. In addition, the surface of the film is quite smooth and crack-free, as seen in FIG. 1a and 1b. The surface roughness around 10 Å over 25 μg m² was measured from atomic force microscopy (shown in FIG. 1b).

The one-step-prepared coating solution in present invention was prepared by mixing TEOS (1 M), deionized water (6-12 M), ethanol, HCl (hydrochloric acid) (0.1-0.4 M) and Tween 80 (polyoxyethylene (20) sorbitan monooleate, MW=1310) at 30° C. for 3 h. TEOS was from Merck and the other chemicals were from Acros. Tween 80 is a non-ionic surfactant, which can form micells and act as a template in the silica colloid solution. The key to simplify our process is to complete the reactions of hydrolysis and polycondensation of TEOS and silanol in the sol-gel in a short period of time. Therefore, we used more acid and water in the sol preparation procedure than the others. It is known that in the sol-gel process under acidic environment, water is the reactant for the hydrolysis of TEOS, and acid is the catalyst for both hydrolysis and polycondensation reactions. Instead of using a long period of reaction time or using an additional reflux procedure, increasing the amount of acid and water in the sol can make both hydrolysis and polycondensation reactions more complete in a short period of time. Moreover, it is found from this research that the solubility of the template in the colloid solution is important for the preparation of porous silica films by our method. Due to higher solubility of Tween than that of P123 triblock copolymer in the solution, the colloid with larger amount of Tween can form porous silica films with lower dielectric constants, however, that with larger amount of P123 can not. Therefore, the surfactants (i.e., Tween), which can be dissolved and form micells in the solution, are more qualified templates used for the preparation of coating solution in this present invention.

The coating solution was spin-coated on a silicon wafer (4 inch or 6 inch) at the speed of 2600 rpm for 30 s. Then the wafer was baked at 106° C. for 3 h and was calcined at 475° C. for 5 h in an air flow. Finally, the film surface was modified to be hydrophobic by immersing it in a HMDS/tolune solution at 80° C., dried at 100° C. for 3 min. For capacitance and leakage current measurement of the film, array of alumina dots with thickness about 5000 Å were formed on the topside of the film by condensation of aluminum vapor through an aluminum shadow mask. The backside of the silicon wafer was etched by HF to remove the native oxide and then thermal coated with aluminum. Capacitance measurements were performed with a Keithley Model 82 CV meter. The frequency and the oscillation level were 1M Hz and 100 mV, respectively. The dielectric constant was calculated from the capacitance, the film thickness and the area of electrode. The leakage current density of the film was determined from the current-voltage (I-V) characteristics measured by a HP4156 semiconductor parameter analyzer. The film thickness was measured from cross-sectional scanning electron microscopy (SEM) taken on an S-800 (Hitachi).

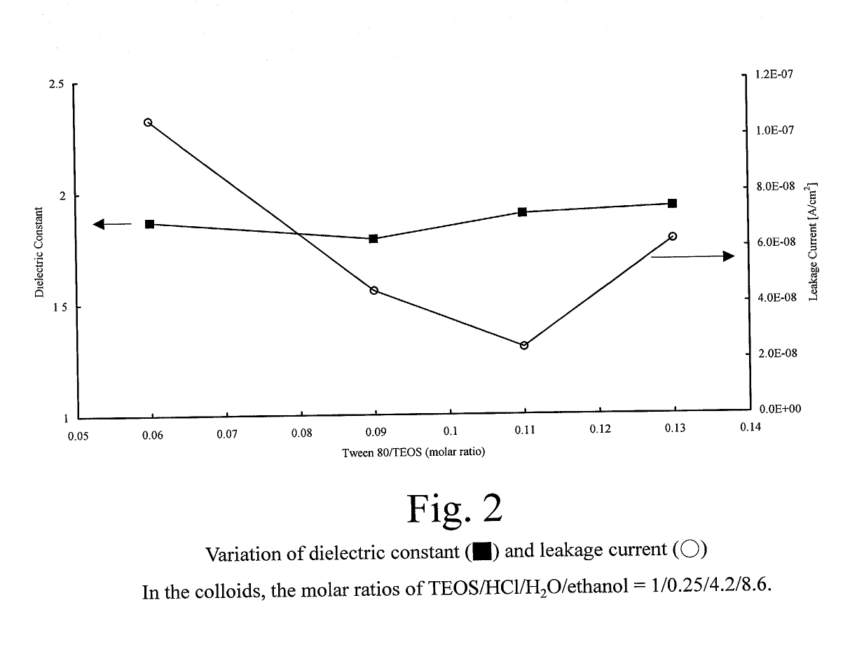

The dielectric constants and the leakage current densities of the films prepared by different amounts of Tween 80 are shown in FIG. 2. In the coating solutions, the molar ratios of TEOS/HCl/H₂O/ethanol were maintained at 1/0.25/4.2/8.6. Because Tween 80 acts as templates in the film and is removed after calcination, if the amount of Tween 80 is increased in the colloid solution, the pore volume in the film is expected to be increased and the dielectric constant of the film is expected to be lowered. Nevertheless, from the data shown in FIG. 2, it can be found that dielectric constants are around 1.9 and are not changed significantly with the amount of Tween 80. In order to investigate what caused this outcome, the bulk silica samples were prepared. Instead of spin coating, a thick layer of colloid on a flat culture dish was quickly dried in a vacuum oven. After baking at 106° C. for 3 h, the samples were scratched from the dish and calcined at 475° C. for 5 h. Nitrogen adsorption-desorption experiments over these samples were conducted for the surface area and the pore size distribution. The results from the detailed analysis of the isotherms are summarized in Table 1. It is found that the major pore sizes of the bulk samples are about 35 Å, which are corresponding to the mesopores. Because approximate 80% of pore volume is contributed by these mesopores, it suggests that the films are composed of pores with uniform size distribution. Besides, it is interesting to find out that the surface areas were increased, however, the pore volumes were nearly the same, when the amount of Tween 80 was increased. Therefore, it is proposed that pores in the samples templated by too much Tween 80 collapsed during the calcination process. This may explain why the dielectric constants in the films, shown in FIG. 2, were not changed with the amount of Tween 80 added in the colloid solution.

TABLE 1
Surface area and pore volume of the films prepared from colloids [a] with
different amounts of Tween 80 as the template.

| Tween 80/ | | | Mesopore | Ratio of Mesopore |
|---|---|---|---|---|
| TEOS (molar | BET Surface Area | Total Pore | Size | Volume to Total |
| ratio) | (m²/g) | Volume (cm³/g) | (Å) | Pore Volume [b] (%) |
| 0.06 | 322 | 0.237 | 35 | 76.12 |
| 0.09 | 426 | 0.305 | 38 | 88.29 |
| 0.11 | 513 | 0.327 | 34 | 88.16 |
| 0.13 | 532 | 0.312 | 34 | 81.10 |

[a] The molar ratios of TEOS/HCl/H₂O/ethanol = 1/0.25/4.2/8.6.
[b]Mesopore Volume is calcualted from pore sizes between 20 Å and 50 Å of isotherm desorption curve.

The effect of water amount in the colloid solution on the dielectric constant of the film was examined in this research. The molar ratios of TEOS/Tween 80/HCl/ethanol in the colloid solution were maintained at 1/0.13/0.25/8.6. It was found that the dielectric constants of the films were gradually reduced from a high value of 7.12, when the molar ratios of H₂O/TEOS were increased from a low value of 0.86. The high dielectric constants at low ratios of water to TEOS strongly indicate that the hydrolysis of TEOS was not complete in the colloid solution for coating. However, when the ratios were increased to values higher than 2.5 (in the range of 2.5 to 8.8), the dielectric constants were around 2 and not significantly changed with the amount of water in the colloid solution. It is known that water is the reagent for the hydrolysis of TEOS and it requires four molecules of water to have a complete conversion of a molecule of TEOS to silanols. Moreover, some of water for hydrolysis are from the products of polycondensation of silanols in the colloid solution. Therefore, it can be concluded that under the reaction conditions designed in this research, the hydrolysis reaction is close to a complete when the molar ratios of H₂O/TEOS are larger than 2.5. In other words, when the molar ratio of H₂O/TEOS is larger than 2.5, the amount of H₂O in the colloid solution is no longer a significant factor to improve the dielectric constant of the films. Therefore, in the later experiments of this research, a molar ratio of H₂O/TEOS at 4.2 was used in the colloid solution.

Except hydrolysis, there is polycondensation reaction in the colloid solution. The longer mixing time for the colloid solution is one of the ways to make the polycondensation reaction more complete, which can increase the mechanical strength of porous silica and may make films with less dielectric constants. In order to understand the effect from mixing time, a series of experiments was carried out in this research. In the colloid solution the molar ratios of TEOS/Tween 80/HCl/H₂O/ethanol at 1/0.13/0.25/4.2/8.6 were used. It was found that dielectric constants of the films were reduced from 1.98, 1.81 to 1.74, when the mixing time were increased from 3 h, 6 h to 9 h. Therefore, if a shorter mixing time, i. e., 3 h, is used, it is apparent that there would be a problem from incomplete polycondensation reactions in the colloid, which cause a higher dielectric constant of the film.

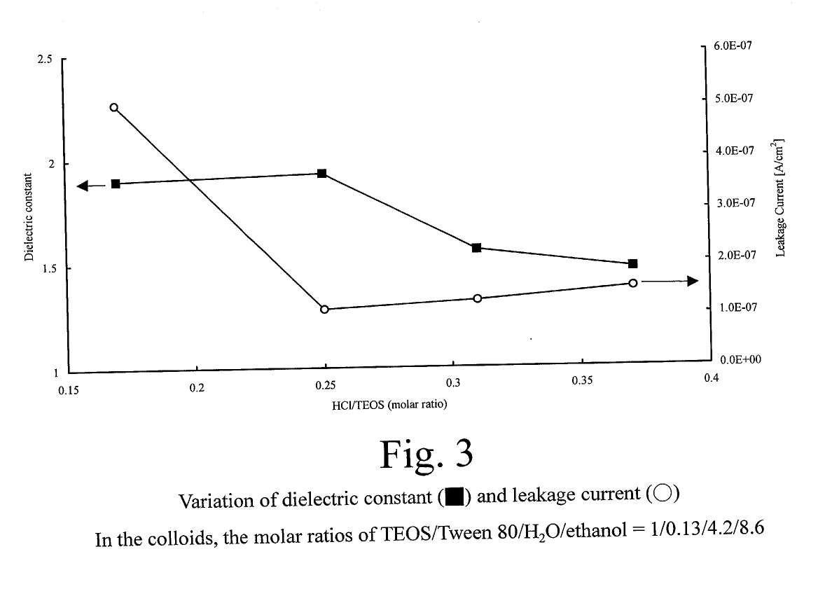

For more complete polycondensation in the colloid while maintaining a short mixing time, i.e., 3 h, the addition of more amount of acid catalyst in the solution may be the way. Therefore, the effect of HCl amount in the colloid on dielectric constants of the films was investigated. The molar ratios of TEOS/Tween 80/H₂O/ethanol were maintained at 1/0.13/4.2/8.6. FIG. 3 shows the dielectric constants and the leakage current densities of the films prepared from colloids with different amount of HCl. It can be observed when the amount of HCl increases, the dielectric constants of the film drop significantly from 1.90 to 1.47, and the leakage current densities drop from 5×10⁻⁷ to 1.2×10⁻⁷ A/cm². These results demonstrate that the addition of more acid catalyst, i.e., HCl, is an effective way to enhance the polycondensation reaction rates in the colloid solution. As a result, silica precursors adsorbed around micelles formed from surfactants of Tween 80 would condensate more completely. As the silanols condensate more completely, there may be two impacts. First, the polar groups (i.e., silanols) in the structure are replaced by nonpolar SiO₂ groups. Second, the structure of colloid silica encapsulated with micelles would be mechanically stronger and the collapse of structure during high-temperature calcination process may be avoided. Both of these two impacts help to reduce the dielectric constant and the leakage current density of the film.

In summary, a simple process was developed in this research for making silica colloid from TEOS with surfactant Tween 80 as the template. By using spin coating, baking, calciantion and surface modification processes, porous silica films on silicon wafers were prepared from this colloid. It was found that these films were with ultra low dielectric constants (1.47 to 1.93) and with low leakage current densities of 10⁻⁷ order. The films were also with very good hydrophobicity so that they were stable in the atmosphere for one month. The porous film made in this research could be an attractive candidate for ultra low dielectric constant materials in future advanced semiconductors interconnects.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claimed:

1. A process for preparing low-dielectric-constant silica film, the dielectric constant of said film being lower than 2.5, said process comprising:
a) preparing spin coating solution, said solution being composed of silica precursor, deionized water, alcohol, single proton acid, and polyoxyethylene (20) sorbitan compounds also known as Tween group compounds as templates; the weight ratio of polyoxyethylene (20) sorbitan compounds over TEOS being more than 0.41;
b) spin-coating the said solution into a film;
c) removing most water and alcohol in said film and making the film react with silicon wafer in soft-bake process;
d) removing said polyoxyethylene (20) sorbitan compound of said film in calcination process; and
e) Modifying said film to hydrophobic by dehydroxylating said film.

2. A process for preparing low-dielectric-constant silica film according to claim 1 wherein said polyoxyethylene (20) sorbitan compounds also known as Tween group compounds are polyoxyethylene (20) sorbitan monolaurate also known as Tween 20 polyoxyethylene (20) sorbitan monopalmitate also known as Tween 40 polyoxyethylene (20) sorbitan monostearate also known as Tween 60 polyoxyethylene (20) sorbitan monooleate also known as Tween 80 or polyoxyethylene (20) sorbitan trioleate also known as Tween 85.

3. A process for preparing low-dielectric-constant silica film according to claim 1 wherein said polyoxyethylene (20) sorbitan compound comprises polyoxyethylene (20) sorbitan monooleate also known as Tween 80.

4. A process for preparing low-dielectric-constant silica film according to claim 1 wherein said silica precursor comprises tetraethyl orthosilicate (TEOS).

5. A process for preparing low-dielectric-constant silica film according to claim 1 wherein said alcohol comprises ethyl alcohol.

6. A process for preparing low-dielectric-constant silica film according to claim 1 wherein said single proton acid comprises hydrochloric acid.

7. A process for preparing low-dielectric-constant silica film according to claim 1 wherein said single proton acid comprises nitric acid.

8. A process for preparing low-dielectric-constant silica film according to claim 1 wherein said spin coating solution is mixed at 20 to 40° C. for less than 9 hours.

9. A process for preparing low-dielectric-constant silica film according to claim 1 wherein said soft bake process is heated in the range of 50 to 200° C. for less than 3 hours.

10. A process for preparing low-dielectric-constant film according to claim 1 wherein said calcination process is operated in the range of 300 to 600° C.

11. A process for preparing low-dielectric-constant silica film, said process comprising:
a) preparing spin coating solution, said solution being composed of tetraethyl orthosilicate (TEOS) deionized water ethyl alcohol single proton acid and polyoxyethylene (20) sorbitan monooleate also known as Tween 80; the molar ratio of said solution being as follow: TEOS: deionized water: ethyl alcohol: single proton acid is 1 to 7: 4 to 8: 9 to 63: 0.8 to 1.7, the weight ratio of polyoxyethylene (20) sorbitan monooleate also known as Tween 80 over TEOS is more than 0.41;
b) spin coating said solution into a film;
c) removing most water and alcohol of said film and making said film react with silicon wafer in soft-bake process;
d) removing said polyoxyethylene (20) sorbitan monooleate also known as Tween 80 of said film in calcination process and
e) Modifying said film to hydrophobic by using silane solution to dehydroxylate said film.

12. A process for preparing low-dielectric-constant silica film according to claim 11 wherein said spin coating solution is mixed at 20 to 40° C. for less than 9 hours.

13. A process for preparing low-dielectric-constant silica film according to claim 11 wherein said soft bake process is operated in the range of 50 to 200° C. for less than 3 hours.

14. A process for preparing low-dielectric-constant film according to claim 11 wherein said calcination process is operated at 300 to 600° C.

15. A process as recited in claim 11, wherein the silicon-based organic compound is a silane.

16. A process as recited in claim 11, wherein the solvent in said silane solution comprises methylbenzene also known as toluene.

17. A process for preparing low-dielectric-constant silica film according to claim 11 wherein said silane solution comprises
hexamethyldisilazane (HMDS) and methylbenzene.

18. A process for preparing low-dielectric-constant silica film according to claim 11 wherein the reaction temperature of said silane solution and said film is in the range of 70 to 110° C.

19. A process for preparing low-dielectric-constant silica film according to claim 11 wherein the molar ratio of silane and solvent is 1.

20. A process for preparing low-dielectric-constant silica film according to claim 11 wherein said film is heated for 3 minutes at 100° C. and cleaned with methylbenzene in order to remove remaining silane solution on said film.
